(19) United States
(12) Patent Application Publication
(10) Pub. No.: US 2009/0151619 A1
(43) Pub. Date: Jun. 18, 2009

(54) DIAL INDICATOR SYSTEM

(76) Inventor: Joseph William Murray, Chesire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/577,772

(22) PCT Filed: Oct. 21, 2005
(86) PCT No.: PCT/GB05/04066

§ 371 Date: Feb. 9, 2009

(30) Foreign Application Priority Data
Oct. 23, 2004 (GB) 0423617.0

(51) Int. Cl. G01D 13/00

(52) U.S. Cl. 116/284

(57) ABSTRACT

A device for indicating the magnitude of a physical parameter, such as pressure, temperature or flow rate, has a movable pointer (1), a receiving antenna (4b, 4c) and a transmitting antenna (4a). The transmitting antenna (4a) generates an electromagnetic field in the vicinity of the pointer (1), so that an electrical signal is induced in the receiving antenna (4b, 4c). An inductive component (3) in the form of an electrically resonant circuit is connected to the pointer (1). Movement of the inductive component (3) in the electromagnetic field generated by the transmitting antenna 4a affects the electrical signal induced in the receiving antenna (4b, 4c) such that the signal induced in the receiving antenna (4b, 4c) is indicative of the displacement of the pointer. The device has the advantage that a simple mechanical indicator can be configured to produce an electrical reading by applying a simple passive inductive component to the pointer (3).

### FIELD OF INVENTION

This invention relates to dial indicators and, in particular, a system to provide local and remote indication of a measured physical parameter.

### BACKGROUND TO THE INVENTION

Dial indicators are commonly used to indicate the magnitude of a physical parameter such as temperature, pressure or flow. Dial indicators are also variously referred to as dial gauges, indicator gauges or analogue gauges. For example, in buildings, dial indicators are used in sprinkler systems to indicate the magnitude of water pressure as a way of checking operability in the event of a fire. The use of such mechanical indicators generally works well in providing local visual indication. In some instances, remote indication may also be required for efficiency, safety or regulatory reasons. For example, in a petrochemical plant, remote electrical signals may be required by a supervisory control and data acquisition computer system to log and control various process parameters such as the temperature in a storage vessel.

Switches may be added to some dial indicators whereby the movement of the pointer causes an electrical contact to open or close. These switch units are available from a variety of companies including Wiebrok Mess Und Regeltechnik GmbH of Herford, Germany.

Using such switch products, an electrical signal can be provided to a remote source indicating that a certain parameter value has been reached. By way of example, a signal can be provided from a boiler's pressure dial indicator to a burner's control system to indicate that the boiler's maximum pressure has been reached. Such systems are typically limited to 3 or 4 switching points and can suffer from reliability problems in dirty, wet or vibrating environments.

Such reliability problems have been partly overcome by the use of reed or inductive switches. Reed switches are triggered by a magnet attached to the pointer. Inductive switches which are triggered by a metallic pointer acting as an inductive target. Both these types of system are relatively expensive and similarly limited to a relatively small number of measurement points.

Local and remote indication can, of course, be provided by using both a dial indicator to provide local indication, and a transducer to provide remote indication. Alternatively, a transducer with a digital display can be employed. Both options are expensive relative to mechanical dial indicators.

U.S. Pat. No. 6,742,396 describes a dial indicator system in which a potentiometer measures the position of the pointer. The pointer carries a magnet which causes the potentiometer's wiper contacts to move using a magnetic coupling through the dial indicator's glass. The system is retrofittable. By their nature, potentiometers are a contacting method of displacement measurement and, consequently, the system is unsuitable for dirty or wet environments—especially considering industry's requirements for long life under harsh duty cycles. Furthermore, there will always be a force required to move the potentiometer's contacts and this will affect the measurement accuracy of the dial indicator. The inherent contact force also makes the system unsuitable for dial indicators with low rotational forces such as tank gauges which are used to measure relatively low liquid head pressures.

U.S. Pat. No. 6,741,184 describes a system for detecting the position of a gauge's pointer using an optical sensing technique. The invention is primarily aimed at automotive speed and fuel gauges. Given that most industrial gauges operate in relatively dirty environments over long periods, such a system would be unsuitable due to problems caused by dirt obscuring or interfering with the light transmission and reception of the sensor.

SU 932236 describes a dial indicator system in which a magnetic pointer cooperates with a series of reed switches arranged along the pointer's travel. Whilst the problems of dirt, electrical contacts and friction are largely overcome, the inherent physical size of the switches means that only a few could be arranged on small gauges and this would prevent precise measurement. Furthermore, reliability problems would arise given the very large numbers of switches needed for precise measurement. False readings would also occur in instances of significant vibration.

This invention provides an inexpensive, robust and accurate system to provide local and remote or just remote indication from a dial indicator, which can either be provided as part of a new dial indicator or retrofitted to a dial indicator which has already been installed.

### SUMMARY OF THE INVENTION

According to the present invention, there is provided a device for indicating the magnitude of a physical parameter, the device comprising:
a movable indicating member;
a receiving antenna;
a transmitting antenna arranged to generate an electromagnetic field in the vicinity of the indicating member, whereby to induce an electrical signal in the receiving antenna, in use; and
   an inductive component mechanically connected to the indicating member for movement therewith, whereby movement of the inductive component in the electromagnetic field generated by the transmitting antenna, in use, affects the electrical signal induced in the receiving antenna such that the signal induced in the receiving antenna is indicative of the displacement of the indicating member.

This invention provides a method and apparatus to measure the position of a pointer in a dial indicator so as to provide local and remote or remote indication.

Preferably, the invention uses a non-contact inductive sensor and an electronics circuit.

Preferably the sensor comprises an electrical intermediate device attached to the dial indicator's pointer and an antenna which further comprises at least one transmit and one receive winding.

Preferably the electrical intermediate device is a resonant circuit comprising an inductor and capacitor in series.

Preferably the electrical intermediate device is an electrically conductive target.

Preferably the antenna is energized with a signal substantially at the same resonant frequency as the resonant electrical intermediate device.

Preferably the electrical intermediate device and antenna are arranged so that displacement of the resonant electrical intermediate device causes a change in the mutual inductance between transmit and receive windings.

Preferably the antenna and electrical intermediate device are constructed using a printed circuit board.

Preferably the electronic circuit includes a memory to store calibration and other data.

Preferably the data is programmed in to the electronic circuit memory by a computer.

### BRIEF DESCRIPTION OF THE DRAWINGS

FIG. 1 shows a known dial indicator.

FIG. 2 shows a plan view of the preferred embodiment installed on a dial indicator.

FIG. 3 shows a sectional view on the centre line of the preferred embodiment installed on a dial indicator.

### DESCRIPTION OF THE PREFERRED EMBODIMENT

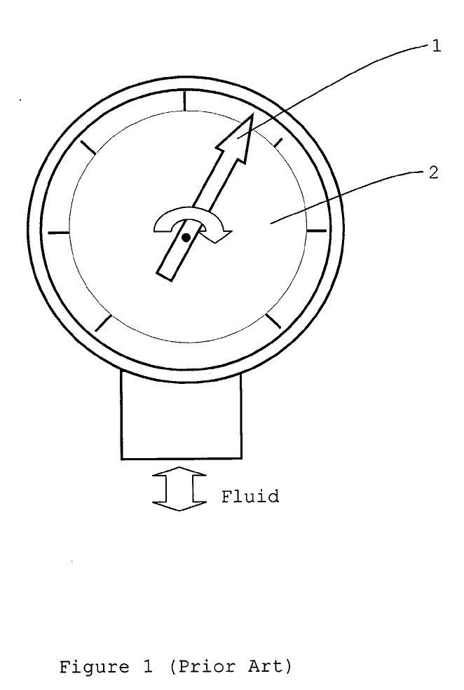

In describing the preferred embodiment, we shall firstly consider the use of an existing, known pressure dial indicator as shown in FIG. 1. In this known dial indicator a pointer [1] rotates relative to a dial [2] according to the pressure of a liquid or gas in a pipe. The pressure of the liquid or gas causes an enclosure [not shown in FIG. 1 for reasons of clarity] contained within the dial indicator to deflect. This deflection is amplified and translated in to rotary displacement of the pointer [1] by a movement or mechanical gear system [not shown in FIG. 1 for reasons of clarity] contained within the dial indicator's housing.

It should be noted that for reasons of brevity, the terms ‘pointer’ and ‘indicating member’ are used to include the amplification and translation mechanisms (e.g. gears, pinions, shafts etc.) inside the dial indicator. Furthermore, the term ‘indicating member’ is used to describe the system which generally provides indication of a physical parameter and covers the multiplicity of dial indicator constructions including, for example, those in which a pointer moves relative to a stationary dial as well as those in which a dial moves relative to a stationary pointer.

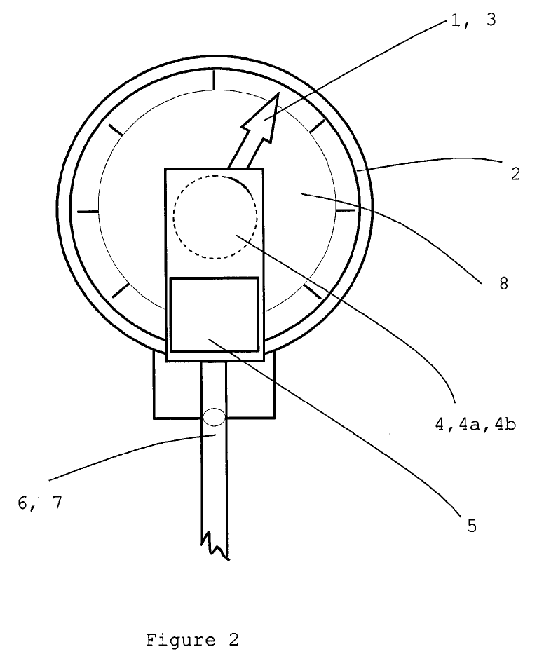

FIG. 2 shows a plan view of a preferred embodiment of the invention. In the preferred embodiment, an inductive sensor is used to measure the rotary displacement of the pointer [1] relative to the dial [2]. Within the inductive sensor there is provided an electrical intermediate device (EID) [3] which is mechanically fixed to the pointer [1]. Preferably the EID [3] is attached at the centre line of the pointer's [1] rotation and is light weight and of minimal moment of inertia so as not to load or hinder the pointer's [1] displacement. The EID [3] is preferably an electrical tank circuit containing an inductance and capacitor in series. Preferably the inductor is produced using an arrangement or winding of tracks on a printed circuit board and together with the capacitor forms a tank circuit with a natural resonant frequency of 2 MHz. A planar antenna [4] is positioned and fixed on the dial indicator's glass [8] above the EID [3]. The antenna [4] is preferably made from 0.8 mm thick FR4 grade printed circuit board material with plated through holes so that loops may be formed without electrical shorting. The antenna [4] preferably contains electrically conductive, copper tracks on an insulating substrate to form a transmit winding [4a] and two receive windings [4b & 4c]. Preferably, the EID [3] is encapsulated with a conformal coating so that humidity or the fluid filling of the dial indicator does not affect it.

Preferably, the circuit board of the antenna [4] also contains an electronics circuit [5] comprising a frequency generating circuit, a transmit circuit, two receive circuits, a microcontroller and an electronic output circuit. Preferably the electronics circuit [5] is embodied as an application specific integrated circuit which also contains flash programmable memory. This memory is provided so as to store a data file containing a number of parameters which are loaded by a computer program prior to operation. These parameters include but are not limited to the position of the pointer at 0% full scale; position of the pointer at 100%; alarm or trigger points within the scale; choice of electrical output; % of hysterisis at the alarm or trigger points; time for averaging the outputs (useful in instances of vibrating dial indicators) and a table of values so as to linearise the electrical output.

Preferably the electrical output is a 4 . . . 20 mA output whereby the 4 mA represents 0% of the measured value and 20 mA of 100% of the measured value. Preferably, the electrical output may be electronically configured by a computer prior to use to provide alternative electrical outputs such as 0-5V, 0-10V, pulse width modulated, bus format or simple digital output suitable for relays.

The frequency generator and transmit circuit supply the transmit winding [4a] of the antenna with an AC signal substantially at the same resonant frequency of the EID [3]. 2 MHz is ideal but the actual choice should preferably be in the range of 100 kHZ to 10 MHz.

The transmit winding [4a] is positioned generally around the periphery of the antenna [4]. The transmit winding [4a] subsequently produces a low power electromagnetic field around the EID [3]. While the EID [3] is in this AC field currents will be induced to flow in it, which create their own electromagnetic field and which, in turn, induce a signal in the receive windings [4b & 4c]. The level of mutual inductance between the transmit [4a] and receive windings [4b & 4c] is dependent on the position of the EID [3] relative to the windings [4a, 4b & 4c]. The signal induced in the receive windings [4b & 4c] is detected by the receive circuit of the electronic circuit [5]. Preferably the receive windings [4b & 4c] are arranged such that the ratio of the voltages induced in them is unique for any position of the pointer [1] and EID [3] assembly at any point of the travel. Preferably, the voltage ratio of the received signals is used to determine the position of the EID [3], and hence pointer, relative to the windings [4b & 4c] and hence the dial [2]. Such antennae [4] and electrical intermediate devices [3] are produced by Zettlex Ltd. of Cambourne, Cambridge, England.

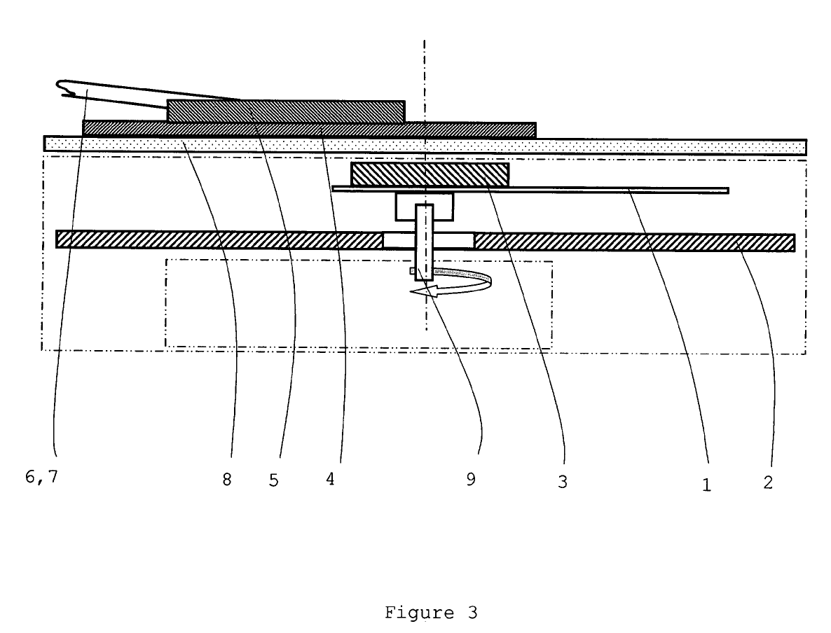

FIG. 3 shows a sectional view of the preferred embodiment and shows the liquid or gas enclosure [9] and a mechanical pinion [11]. Power is supplied to the electronics circuit [5] by wires [6] which are preferably contained within a multiwire cable [7] also containing wires for the electronic output.

### OTHER EMBODIMENTS & MODIFICATIONS

It will be appreciated by those skilled in the art that the invention may be applied to dial indicators of various sizes and types—whether linear, curvilinear or rotary.

Further, the invention may be used with dial indicators with more than one pointer. In such instances, an EID [3] may be attached to each of the pointers [1]. Preferably the resonant frequency of the EID's [3] differ substantially, for example 1 and 2 MHz, so that the system may differentiate between the pointers [1] and output electrical signals accordingly.

Furthermore, the invention may be applied to wide variety of dial indicators used to measure pressure, temperature, flow, pressure drop, viscosity, flow rate, liquid level etc.

The electrical output from the electronics circuit may be fed to one or more relays so that high voltages may be switched.

In order to avoid rapid, repetitive triggering of the relays the triggers points may be provided with a hysterisis level. This may be set in the parameters stored in the electronic circuit's memory.

Trigger or alarm points may be recorded for local indication by self adhesive labels attached to the dial indicator's glass.

The use of a resonant electrical intermediate device is not necessary. An alternative but less preferable EID [3] is a simple conductive target such as a copper disk.

An alternative to an inductive sensor is a Hall effect or giant magnetoresistive sensor where a magnet is attached to the pointer [1] and the sensor is attached to the glass [12]. This is not preferred due to the magnetic susceptibility of such devices; batch to batch variability of magnets and the requirement to precisely align the magnet with the sensor to ensure accurate readings.

In summary, a device for indicating the magnitude of a physical parameter, such as pressure, temperature or flow rate, has a movable pointer, a receiving antenna and a transmitting antenna. The transmitting antenna generates an electromagnetic field in the vicinity of the pointer, so that an electrical signal is induced in the receiving antenna. An inductive component in the form of an electrically resonant circuit is connected to the pointer. Movement of the inductive component in the electromagnetic field generated by the transmitting antenna affects the electrical signal induced in the receiving antenna such that the signal induced in the receiving antenna is indicative of the displacement of the pointer. The device has the advantage that a simple mechanical indicator can be configured to produce an electrical reading by applying a simple passive inductive component to the pointer.

1. A device for indicating the magnitude of a physical parameter, the device comprising:
a movable indicating member;
a receiving antenna;
a transmitting antenna arranged to generate an electromagnetic field in the vicinity of the indicating member, whereby to induce an electrical signal in the receiving antenna, in use; and
an inductive component mechanically connected to the indicating member for movement therewith, whereby movement of the inductive component in the electromagnetic field generated by the transmitting antenna, in use, affects the electrical signal induced in the receiving antenna such that the signal induced in the receiving antenna is indicative of the displacement of the indicating member.

2. A device as claimed in claim 1, wherein the inductive component comprises a resonant electrical circuit comprising an inductor and capacitor in series.

3. A device as claimed in claim 2, wherein the transmitting antenna is arranged to generate an electromagnetic field having a frequency corresponding substantially to the resonant frequency of the resonant electrical circuit.

4. A device as claimed in claim 1 comprising a signal processing circuit configured to process the electrical signal induced in the receiving antenna to generate an output signal corresponding to the magnitude of the physical parameter.

5. A device as claimed in claim 4, wherein the signal processing circuit is configured to store calibration data for correlating the electrical signal induced in the receiving antenna with the magnitude of the physical parameter.

6. A device as claimed in claim 1 comprising a mechanical sensing element connected to the indicating member, wherein the sensing element is mechanically sensitive to the physical parameter and is arranged to move the indicating member, in use, in response to changes in the magnitude of the physical parameter.

7. A device as claimed in claim 1, wherein the indicating member is arranged to rotate to indicate the magnitude of the physical parameter.

8. A device as claimed in claim 7, wherein the receiving antenna and/or the transmitting antenna is mounted over the centre of rotation of the indicating device.

9. A device as claimed in claim 1, wherein the inductive component is mounted to the indicating member.

10. A device as claimed in claim 1, wherein the transmitting antenna and the receiving antenna are substantially coplanar.

11. A device as claimed in claim 1, wherein the transmitting antenna and the receiving antenna are formed on a printed circuit board.

12. A device as claimed in claim 1 comprising a plurality of receiving antennae, whereby the position of the inductive component is determinable from a comparison of the respective electrical signals induced in the receiving antennae.

13. A device as claimed in claim 1, wherein the device comprises a plurality of indicating members each mechanically connected to respective inductive components, with each inductive components comprising a resonant electrical circuit having a different resonant frequency.

14. A device as claimed in claim 1, wherein the physical parameter is pressure, temperature or flow rate.

15. A kit for mounting to an indicating device for a physical parameter to provide a device as claimed in claim 1, the kit comprising:
an inductive component for mechanical connection to an indicating member of the indicating device;
a receiving antenna; and
a transmitting antenna for generating an electromagnetic field in the vicinity of the indicating member, whereby to induce an electrical signal in the receiving antenna, in use,
whereby movement of the inductive component in the electromagnetic field generated by the transmitting antenna, in use, affects the electrical signal induced in the receiving antenna such that the signal induced in the receiving antenna is indicative of the displacement of the indicating member.
